(19) United States
(12) Patent Application Publication
(10) Pub. No.: US 2026/0137966 A1
(43) Pub. Date: May 21, 2026

(54) CLAMPING ASSEMBLY FOR A FALL RESTRAINT SYSTEM OF A TRAILER

(71) Applicant: JMC Enterprises, Inc., Syracuse, NY (US)

(72) Inventors: Jonathan Campbell, La Fayette, NY (US); Joseph Palumbo, East Syracuse, NY (US)

(21) Appl. No.: 19/371,177

(22) Filed: Oct. 28, 2025

Related U.S. Application Data
(60) Provisional application No. 63/721,694, filed on Nov. 18, 2024.

(51) Int. Cl. A62B 35/00

(52) U.S. Cl. CPC A62B 35/0068

(57) ABSTRACT

A clamping assembly for a fall restraint system, the clamping assembly including an arm, including a first end, a second end, and a slot, a first plate connected to the first end, an engaging member slidably connected to the arm, the engaging member displaceable in a first direction and a second direction, opposite the first direction, a second plate connected to the arm and including a first surface and a second surface, and a tensioning device operatively arranged to displace the engaging member in the second direction.

### CROSS-SECTION TO RELATED APPLICATIONS

This application claims the benefit under 35 U.S.C. § 119(e) of U.S. Provisional Application No. 63/721,629, filed November 18, 2024, which application is incorporated herein by reference in its entirety.

### FIELD

The present disclosure relates to safety apparatuses, and more particularly, to a fall restraint assembly including a clamping assembly for use with semi-trailers and other tall structures that prevents injury from falling.

### BACKGROUND

In geographic areas of significant snowfall, snow and ice on the roof of semi-trailers, also known as tractor-trailers, and other heavy machinery presents a significant driving hazard. Snow and ice accumulation on the roof of vehicles can come dislodged at driving speed and become airborne. This snow and ice can then cause significant harm to other vehicles and their occupants. Snow removal from semi-trailers prior to driving is currently mandated by the U.S. Department of Transportation in many northern states.

Current technology relies on a scraper system where semi-trailers travel underneath a fixed or moveable bar that removes the snow from the roof of the semi-trailer as it passes through the structure. However, these systems do not always completely remove ice and packed snow from the roof structure of the trailer and thus still present a hazard to other drivers.

In many instances it is necessary for a person to physically get on the roof of the semi-trailer to break up and remove ice and snow to best make the trailer safe. However, traversing the top of a semi-trailer that is covered in deep snow or ice also presents a significant hazard. Slippery conditions that are often accompanied by cold temperatures and reduced visibility present a harsh work environment and significant risk of a fall from the roof of the trailer.

### SUMMARY

It is an object of the present disclosure to provide a clamping assembly for a fall restraint system of a trailer.

The present disclosure is directed to one or more exemplary embodiments of a clamping assembly for a fall restraint system.

In an exemplary embodiment, the clamping assembly comprises an arm, including a first end, a second end, and a slot, a first plate connected to the first end, an engaging member slidably connected to the arm, the engaging member displaceable in a first direction and a second direction, opposite the first direction, a second plate connected to the arm and including a first surface and a second surface, and a tensioning device operatively arranged to displace the engaging member in the second direction.

In an exemplary embodiment, the second plate is connected to the arm via a beam. In an exemplary embodiment, the beam is connected to a top surface of the arm. In an exemplary embodiment, the second plate is spaced apart from the arm in a third direction, perpendicular to the first direction and the second direction. In an exemplary embodiment, the clamping assembly further comprises a coupling device connected to second plate.

In an exemplary embodiment, the engaging member comprises a top bracket including a first finger. In an exemplary embodiment, the top bracket comprises a post and the first finger extends from the post in the second direction. In an exemplary embodiment, the engaging member further comprises a bottom bracket, and a connector extends through the bottom bracket, the slot, and the top bracket to slidably connect the engaging member to the arm. In an exemplary embodiment, the first plate comprises a second finger extending in the first direction toward the first finger.

In an exemplary embodiment, the tensioning device comprises a rod connected to the engaging member. In an exemplary embodiment, the rod comprises threading and is threadably engaged with the first end. In an exemplary embodiment, the rod comprises threading and is threadably engaged with a hole in the first plate. In an exemplary embodiment, the first surface comprises a rubber pad. In an exemplary embodiment, the coupling device comprises an eyebolt.

The present disclosure is directed to one or more exemplary embodiments of a fall restraint system.

In an exemplary embodiment, the fall restraint assembly comprises a clamping assembly, including an arm, comprising a first end, a second end, and a slot, a first plate connected to the first end, an engaging member slidably connected to the arm, the engaging member displaceable in a first direction and a second direction, opposite the first direction, a second plate connected to the arm and including a first surface and a second surface, and a tensioning device operatively arranged to displace the engaging member in the second direction, and a line connected to the second plate.

In an exemplary embodiment, the clamping assembly further comprises a coupling device connected to the second plate, and the line is connected to the coupling device. In an exemplary embodiment, the engaging member comprises a first finger extending in the second direction. In an exemplary embodiment, the first plate comprises a second finger extending in the first direction. In an exemplary embodiment, the second plate is fixedly secured to the arm via a beam, and the beam is connected to a top surface of the arm. In an exemplary embodiment, the first plate is arranged substantially perpendicular to the second plate.

These and other objects, features, and advantages of the present disclosure will become readily apparent upon a review of the following detailed description of the disclosure, in view of the drawings and appended claims.

### BRIEF DESCRIPTION OF THE DRAWING

The accompanying drawings are incorporated herein as part of the specification. The drawings described herein illustrate embodiments of the presently disclosed subject matter and are illustrative of selected principles and teachings of the present disclosure, in which corresponding reference symbols indicate corresponding parts. However, the drawings do not illustrate all possible implementations of the presently disclosed subject matter and are not intended to limit the scope of the present disclosure in any way.

FIG. 1A is a front perspective view of a fall restraint assembly, in accordance with embodiments of the present disclosure.

FIG. 1B is a front perspective view of the fall restraint assembly shown in FIG. 1A, in accordance with embodiments of the present disclosure.

FIG. 1C is a rear perspective view of the fall restraint assembly shown in FIG. 1A, in accordance with embodiments of the present disclosure.

FIG. 1D is a front perspective view of the fall restraint assembly shown in FIG. 1A, in accordance with embodiments of the present disclosure.

FIG. 2A is a right side elevational view of the clamping assembly shown in FIG. 1A.

FIG. 2B is a left side elevational view of the clamping assembly shown in FIG. 1A, with the attachment device removed.

FIG. 2C is a top plan view of the clamping assembly shown in FIG. 1A.

FIG. 2D is a front elevational view of the clamping assembly shown in FIG. 1A.

FIG. 2E is a rear elevational view of the clamping assembly shown in FIG. 1A

### DETAILED DESCRIPTION

It is to be understood that the invention may assume various alternative orientations and step sequences, except where expressly specified to the contrary. It is also to be understood that the specific assemblies and systems illustrated in the attached drawings and described in the following specification are simply exemplary embodiments of the inventive concepts defined herein. Hence, specific dimensions, directions, or other physical characteristics relating to the embodiments disclosed are not to be considered as limiting, unless expressly stated otherwise. Also, although they may not be, like elements in various embodiments described herein may be commonly referred to with like reference numerals within this section of the application.

Furthermore, it is understood that this disclosure is not limited to the particular methodology, materials and modifications described and as such may, of course, vary. It is also understood that the terminology used herein is for the purpose of describing particular aspects only, and is not intended to limit the scope of the claims.

Unless defined otherwise, all technical and scientific terms used herein have the same meaning as commonly understood to one of ordinary skill in the art to which this disclosure pertains. It should be understood that any methods, devices or materials similar or equivalent to those described herein can be used in the practice or testing of the example embodiments.

Where used herein, the terms “first,” “second,” and so on, do not necessarily denote any ordinal, sequential, or priority relation, but are simply used to more clearly distinguish one element or set of elements from another, unless specified otherwise.

Where used herein, the term “about” when applied to a value is intended to mean within the tolerance range of the equipment used to produce the value, or, in some examples, is intended to mean plus or minus 10%, or plus or minus 5%, or plus or minus 1%, unless otherwise expressly specified.

It should be appreciated that the term “substantially” is synonymous with terms such as “nearly,” “very nearly,” “about,” “approximately,” “around,” “bordering on,” “close to,” “essentially,” “in the neighborhood of,” “in the vicinity of,” etc., and such terms may be used interchangeably as appearing in the specification and claims. It should be appreciated that the term “proximate” is synonymous with terms such as “nearby,” “close,” “adjacent,” “neighboring,” “immediate,” “adjoining,” etc., and such terms may be used interchangeably as appearing in the specification and claims. The term “substantially” is intended to mean values within ten percent of the specified value.

Where used herein, the term “exemplary” is intended to mean “an example of,” “serving as an example,” or “illustrative,” and does not denote any preference or requirement with respect to a disclosed aspect or embodiment.

It should be understood that use of “or” in the present application is with respect to a “non-exclusive” arrangement, unless stated otherwise. For example, when saying that “item x is A or B,” it is understood that this can mean one of the following: (1) item x is only one or the other of A and B; (2) item x is both A and B. Alternately stated, the word “or” is not used to define an “exclusive or” arrangement. For example, an “exclusive or” arrangement for the statement “item x is A or B” would require that x can be only one of A and B. Furthermore, as used herein, “and/or” is intended to mean a grammatical conjunction used to indicate that one or more of the elements or conditions recited may be included or occur. For example, a device comprising a first element, a second element and/or a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element.

Moreover, as used herein, the phrases “comprises at least one of” and “comprising at least one of” in combination with a system or element is intended to mean that the system or element includes one or more of the elements listed after the phrase. For example, a device comprising at least one of: a first element; a second element; and a third element, is intended to be construed as any one of the following structural arrangements: a device comprising a first element; a device comprising a second element; a device comprising a third element; a device comprising a first element and a second element; a device comprising a first element and a third element; a device comprising a first element, a second element and a third element; or a device comprising a second element and a third element. A similar interpretation is intended when the phrase “used in at least one of:” is used herein.

By “non-rotatably connected” elements, it is meant that the elements are connected so that whenever one of the elements rotate, all the elements rotate, and relative rotation between the elements is not possible. Radial and/or axial movement of non-rotatably connected elements with respect to each other is possible, but not required. By “rotatably connected” elements, it is mean that the elements are rotatable with respect to each other.

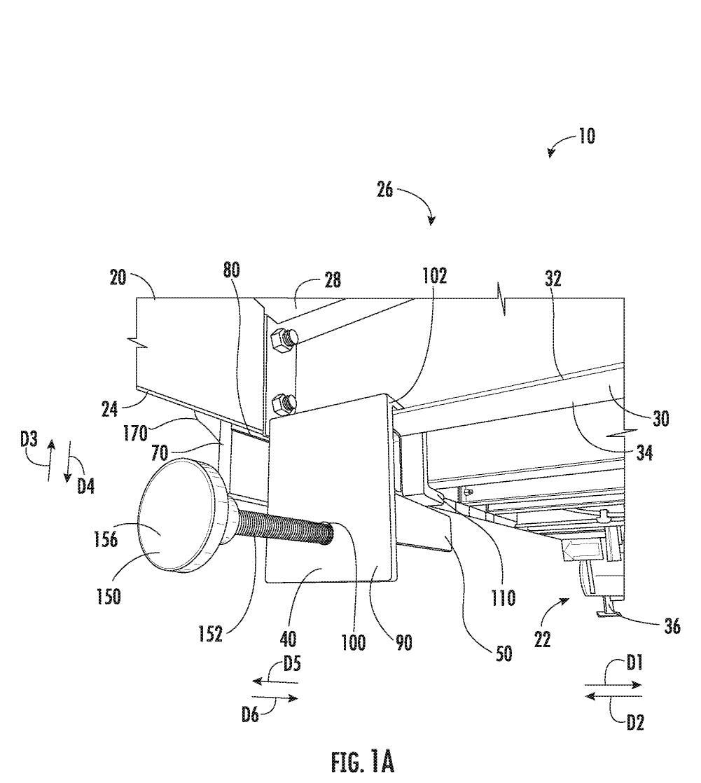

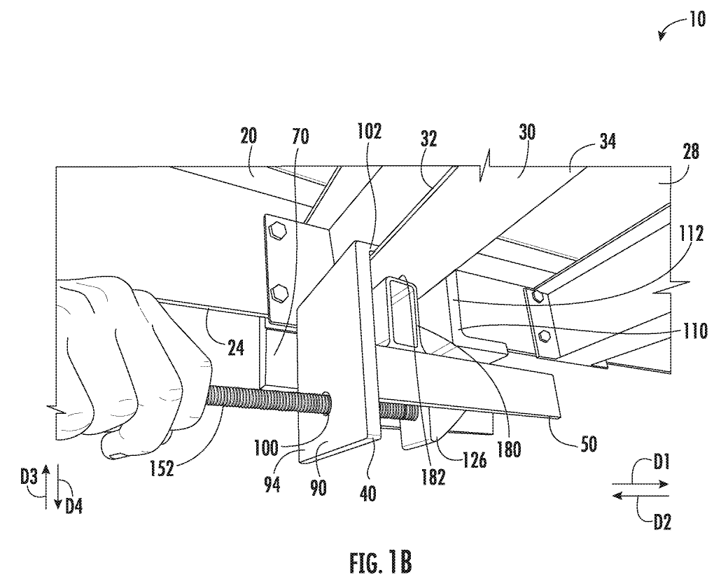

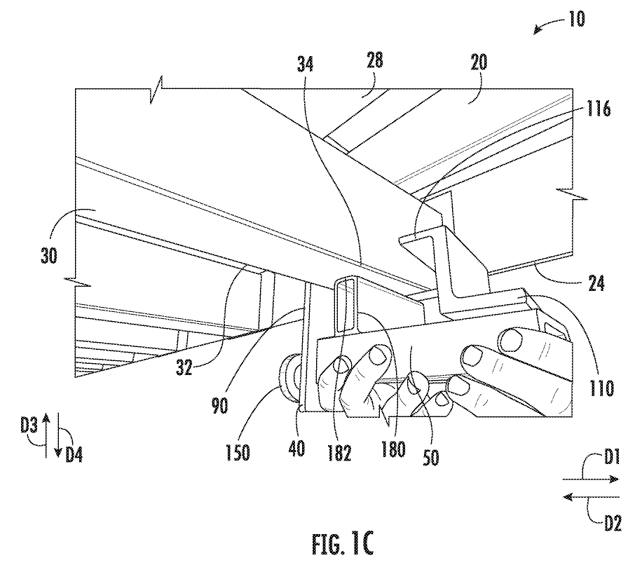

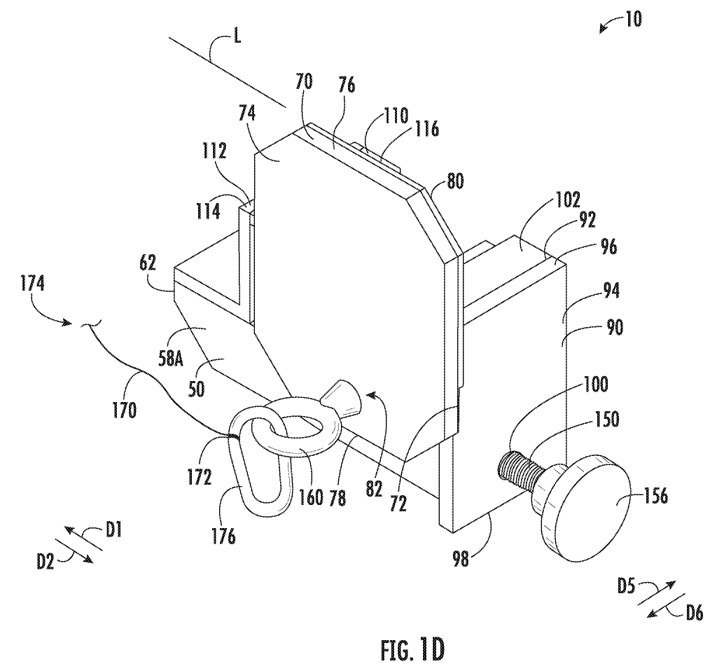

Adverting now to the figures, FIG. 1A is a front perspective view of fall restraint assembly 10, in accordance with embodiments of the present disclosure. FIG. 1B is a front perspective view of fall restraint assembly 10. FIG. 1C is a rear perspective view of fall restraint assembly 10. FIG. 1D is a front perspective view of fall restraint assembly 10. Fall restraint assembly 10 comprises clamping assembly 40. In an exemplary embodiment, fall restraint assembly 10 further comprises line 170. In an exemplary embodiment, fall restraint assembly 10 further comprises connector 176.

In some embodiments, fall restraint assembly 10 is arranged on semi-trailer or tractor-trailer 20; however, it should be appreciated that fall restraint assembly 10 can be utilized for any infrastructure where falling is a risk, for example, a building, bridge, aircraft, etc. Semi-trailer 20 comprises front (not shown), rear 22, side 24, top 26, and bottom 28. Bottom 28 is formed of and/or comprises one or more beams 30. In an exemplary embodiment beam 30 is an I beam. Beam 30 comprises flange 34 extending in direction D1 and flange 32 extending in direction D2. Clamping assembly 40 is operatively arranged to engage beam 30 and/or flanges 32 and 34 to secure line 170 to semi-trailer 20, as will be described in greater detail below.

Semi-trailer 20 further comprises front support or landing gear 36 extending in direction D4 from bottom 28. Landing gear 36 comprises at least one leg, for example, two legs. The legs may be extendable and retractable, for example, when semi-trailer 20 is not connected to a semi-truck and connected to a semi-truck, respectively. Landing gear 36 may comprise other support componentry known in the art, for example, leg sleeves to which the legs are telescopingly engaged, landing gear feet connected to the distal ends of the legs (and engage the ground surface), one or more gussets extending between bottom 28 and the legs to add support, additional support beams, etc. Semi-trailer 20 further comprises a rear impact guard or bumper (not shown) arranged proximate rear 22 and one or more wheels (not shown). It should be appreciated that landing gear 36 and bumper are fixedly secured to semi-trailer 20, for example bottom 28.

Line 170 is a cable, rope, strap, chain, string, or the like comprising end 172 and end 174. End 172 is arranged to be connected to clamping assembly 40. In an exemplary embodiment, end 172 is connected to clamping assembly 40, namely, attachment device or eyebolt or hook or loop 160, via connector 176. Connector 176 may comprise any suitable coupling link, preferably with a safety closure, for example a carabiner. In an exemplary embodiment, end 174 is arranged to be connected, either directly or indirectly, to a safety harness (not shown). It should be appreciated that ends 172 and 174 of line 170 may be connected to clamping assembly 40 and the safety harness, respectively, via any suitable means, for example, a choker hitch, a clamp, a carabiner, a J-hook, etc.

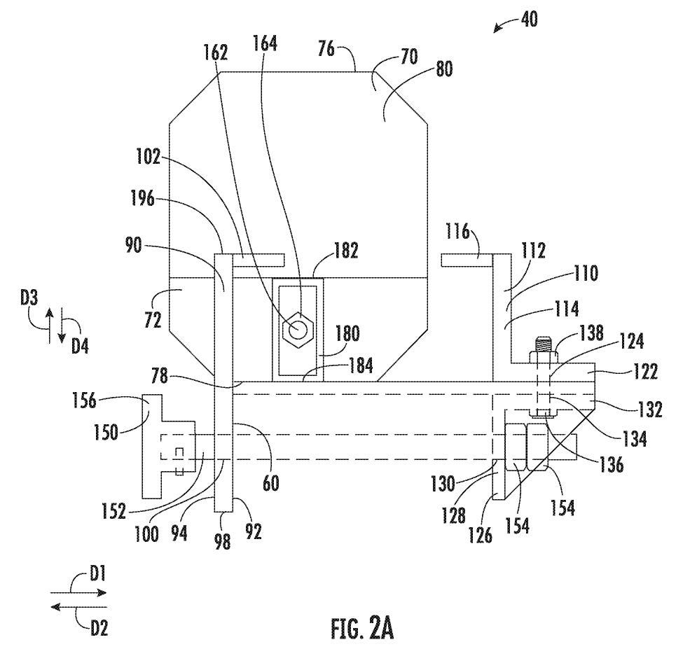

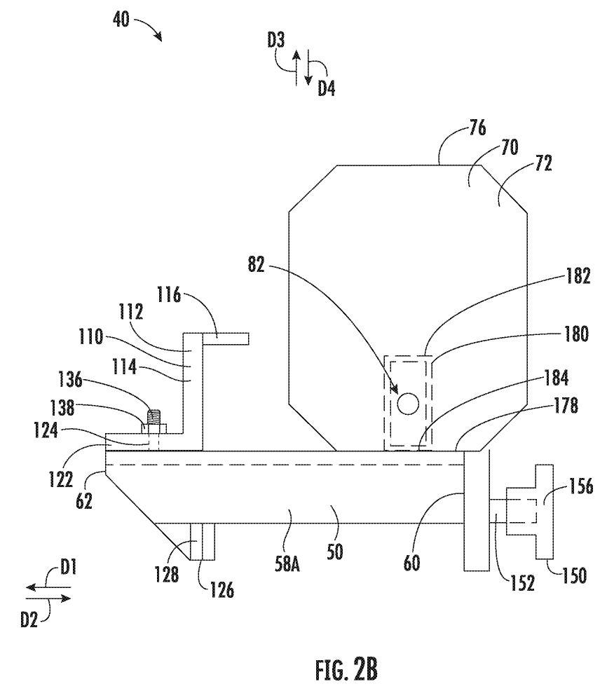

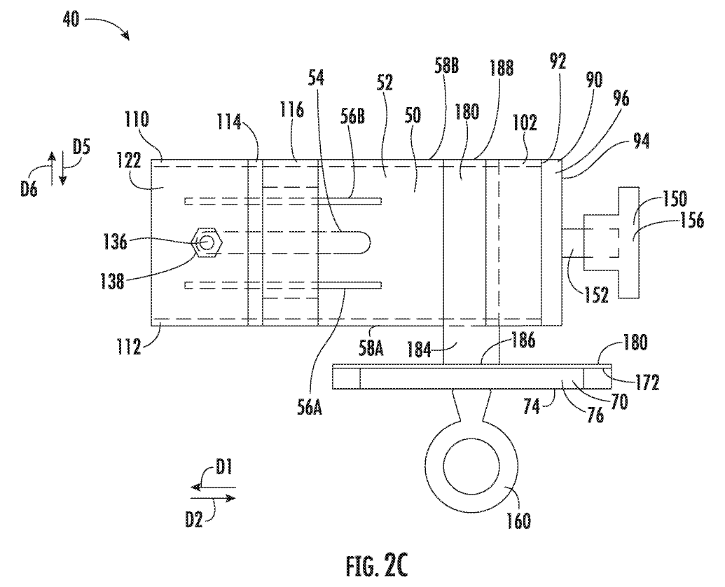

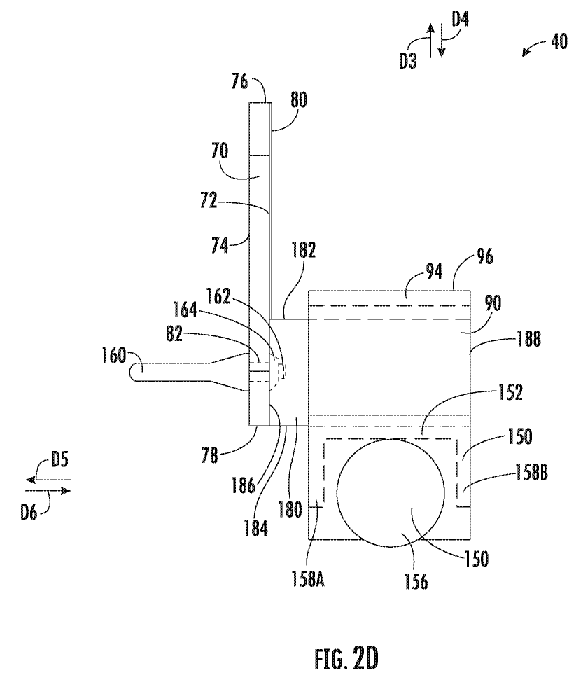

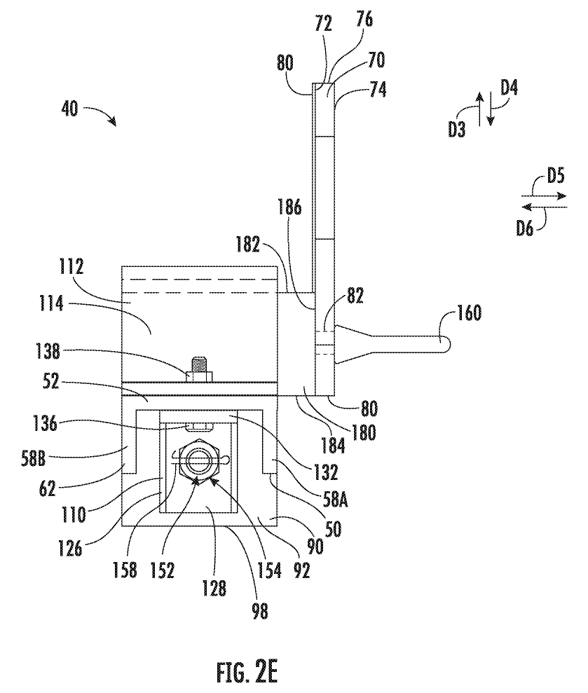

FIG. 2A is a right side elevational view of clamping assembly 40. FIG. 2B is a left side elevational view of clamping assembly 40, with attachment device 160 removed. FIG. 2C is a top plan view of clamping assembly 40. FIG. 2D is a front elevational view of clamping assembly 40. FIG. 2E is a rear elevational view of clamping assembly 40. Clamping assembly 40 generally comprises arm 50, plate 70, plate 90, engaging member 110, and tensioning device 150. In an exemplary embodiment, clamping assembly 40 further comprises beam 180.

Arm 50 comprises plate or top surface 52, end 60, and end 62. Plate 52 comprises slot 54 extending completely through plate 52 to facilitate connection of engaging member 110 with arm 50. Slot 54 extends along plate 52 generally in direction D1, D2. In an exemplary embodiment, plate 52 further comprises one or more grooves, for example, grooves 56A-56B. Grooves 56A-56B comprise grease to facilitate sliding connection of engaging member 110 with arm 50. That is, grease is arranged in grooves 56A-56B. In an exemplary embodiment, arm 50 further comprises plate 58A and/or plate 58B extending in direction D4 from plate 52. Plate 58A is arranged on a first lateral side of plate 52 and plate 58B is arranged on a second lateral side of plate 52, opposite the first lateral side. In an exemplary embodiment, plate 58B is arranged parallel to plate 58A.

Plate 70 is connected to arm 50. In an exemplary embodiment, and as shown, plate 70 is fixedly secured to arm 50 via beam 180. Plate 70 comprises surface 72, surface 74, top 76, and bottom 78. In an exemplary embodiment, plate 70 is fixedly secured to end 186 of beam 180. Surface 72 faces generally in direction D6 and is engaged with end 186 of beam 180. Plate 70 is spaced apart in direction D5 from arm 50. Surface 72 is operatively arranged to engage side 24 of semi-trailer 20, for example, to help stabilize clamping assembly 40. In an exemplary embodiment, surface 72 comprises gripping material or pad or strip 80 operatively arranged to prevent sliding displacement of plate 70 with respect to side 24 and the scratching of side 24 via plate 70. In an exemplary embodiment, pad 80 comprises rubber. In an exemplary embodiment, pad 80 does not cover the entirety of surface 72, but is spaced apart from bottom 78. In an exemplary embodiment, a shim (not shown) is arranged between plate 70 and/or pad 80 and side surface 24 of semi-trailer 20. In an exemplary embodiment, top 76 is arranged elevationally higher than, or spaced apart in direction D3 from, bottom 28 of semi-trailer 20, and bottom 78 is arranged elevationally lower than, or spaced apart in direction D4 from, flanges 32 and 34 of semi-trailer 20. In an exemplary embodiment, surface 72 of plate 70 is arranged parallel with line L (see FIG. 1D), which extends in direction D1 and direction D2, and surface 92 of plate 90 is perpendicular to line L (i.e., surface 92 extends in direction D5 and direction D6).

Beam 180 comprises top surface 182, bottom surface 184, end 186, and end 188. Bottom surface 184 is connected to plate 52 of arm 50. In an exemplary embodiment, beam 180 is fixedly secured to arm 50. Beam 180 is arranged between and spaced apart from end 60 and end 62 of arm 50. Top surface 182 is operatively arranged to engage the bottom surface of beam 30 to align fingers 116 and 102 with the top surfaces of flanges 34 and 32, respectively, as will be described in greater detail below. End 186 is spaced apart from arm 50 in direction D5 and is connected to surface 72 of plate 70. In an exemplary embodiment, end 188 is aligned with plate 58B. In an exemplary embodiment, beam 180 is a tube. Beam 180 is fixed with respect to, and spaced apart from, plate 90.

Attachment device 160 is operatively arranged to be connected to plate 70. In an exemplary embodiment, plate 70 comprises hole 82 operatively arranged to facilitate connection of attachment device 160 with plate 70. For example, hole 82 may be a through-bore through which bolt 162 extends. Attachment device 160 is then secured to plate 70 via bolt 164. It should be appreciated, however, that attachment device 160 may be connected to plate 70 via any suitable means, for example, welding, brazing, adhesive, etc. Attachment device 160 facilitates the connection of line 170 to clamping assembly 40, and also acts as a standoff to prevent line abrasion and damage to trailer paint. Line protection such as coatings and concentric tubular structures (e.g., a sheath) may also be applied to prevent abrasion of the lines, to improve device longevity. For example, attachment device 160 moves the connection point of line 170 with semi-trailer 20 outward from the wheels, past the edge or side 24 of semi-trailer 20. In an exemplary embodiment, attachment device 160 comprises a threaded eye-bolt.

Clamping assembly 40 further comprises plate 90. Plate 90 is connected to arm 50 at end 60. Plate 90 comprises surface 92, surface 94, top 96, and bottom 98. In an exemplary embodiment, plate 90 is fixedly secured to end 60 of arm 50. Surface 92 faces generally in direction D1 and is engaged with end 60 of arm 50. Plate 90 further comprises hole or through-bore 100 operatively arranged to engage tensioning device 150. In an exemplary embodiment, through-bore 100 is a threaded hole arranged to engage threaded rod 152 such that, as threaded rod 152 is rotated in a first circumferential direction, rod 152 is displaced in direction D1, and as threaded rod 152 is rotated in a second circumferential direction opposite the first circumferential direction, rod 152 is displaced in direction D2. In an exemplary embodiment, finger 102 is fixedly secured to plate 90, for example at top 96. Finger 102 extends generally in direction D1 from surface 92. In an exemplary embodiment, finger 102 is perpendicular to surface 92. Finger 102 is spaced apart from top surface 182 of beam 180 in direction D3. This space corresponds to the thickness of flange 32, 34.

Engaging member 110 comprises top bracket 112 and bottom bracket 126, and is operatively arranged to engage beam 30 of semi-trailer 20. Top bracket 112 is slidingly and/or translatably connected to the top surface of plate 52 and bottom bracket 126 is slidingly and/or translatably connected to the bottom surface of plate 52. Top bracket 112 comprises base 122 and post 114. Base 122 is slidably arranged on the top surface of plate 52. In an exemplary embodiment, base 122 comprises through-hole 124 operatively arranged to engage bolt 136 to connect top bracket 112 to arm 50.

Post 114 is connected to base 122 and extends therefrom generally in direction D3. In an exemplary embodiment, post 114 is fixedly secured to base 122 at its proximal end. In an exemplary embodiment, post 114 is arranged perpendicular to base 122. Post 114 comprises one or more fingers, for example, finger 116, arranged at its distal end. Finger 116 is arranged to engage beam 30. For example, finger 116 is arranged elevationally above flange 34 and arranged to engage a top surface thereof. In an exemplary embodiment, finger 116 is arranged perpendicular to post 114. Finger 116 is spaced apart from top surface 182 of beam 180 in direction D3. This space corresponds to the thickness of flange 32, 34.

Bottom bracket 126 comprises base 132 and post 128. Base 132 is slidably arranged on the bottom surface of plate 52. In an exemplary embodiment, base 132 comprises through-hole 134 operatively arranged to engage bolt 136 to connect bottom bracket 126 to arm 50. Specifically, bolt 134 is fed through hole 134, slot 54, and hole 124 either in direction D3 or direction D4, and nut 138 is connected thereto thereby slidably connecting top bracket 112 and bottom bracket 126 to arm 50.

Post 128 is connected to base 132 and extends therefrom generally in direction D4. In an exemplary embodiment, post 128 is fixedly secured to base 132 at its proximal end. In an exemplary embodiment, post 128 is arranged perpendicular to base 132. In an exemplary embodiment, bottom bracket 126 comprises one or more trusses or plates extending between post 128 and base 132 for added support. Post 128 comprises through-bore 130 operatively arranged to engage rod 152. Specifically, threaded rod 152 is fed through hole 130 in post 128 in direction D1 and connector or nut 154 is connected to the distal end of threaded rod 152. In an exemplary embodiment, as threaded rod 152 is displaced in direction D2 engaging member 110 is displaced in direction D2, but as threaded rod 152 is displaced in direction D1 engaging member 110 may not be displaced in direction D1. That is, bottom bracket 126 is not fixed to threaded rod 152. In an exemplary embodiment, as threaded rod 152 is displaced in direction D2 engaging member 110 is displaced in direction D2 and as threaded rod 152 is displaced in direction D1 engaging member 110 is displaced in direction D1 (e.g., bottom bracket 126 is fixed to threaded rod 152).

Tensioning device 150 is operatively arranged to displace engaging member 110 into engagement with beam 30 in order to secure clamping assembly 40 to semi-trailer 20. Specifically, tensioning device 150 is arranged to displace engaging member 110 in direction D2 to engage beam 30. Tensioning device 150 comprises rod 152 including a distal end connected to bottom bracket 128 and a proximal end. In an exemplary embodiment, knob 156 is non-rotatably connected to the proximal end of rod 152 (e.g., via a set screw). As previously described, in an exemplary embodiment, rod 152 is a threaded rod that is threadably engaged with threaded through-bore 100 in plate 90. As threaded rod 152 is rotated in a first circumferential direction, for example via knob 156, rod 152 is displaced in direction D1 with respect to plate 90, and as threaded rod 152 is rotated in a second circumferential direction rod 152 is displaced in direction D2 with respect to plate 90. In an exemplary embodiment, rod 152 is connected to bottom bracket 128 via lock nut 154. As previously described, in an exemplary embodiment nut 154 prevents displacement of engaging member 110 in direction D1 with respect to rod 152, but engaging member 110 is displaceable in direction D2 with respect to rod 152 (i.e., when bottom bracket 126 is not fixed to rod 152). In an exemplary embodiment, bottom bracket 126 is fixed to rod 152 and thus cannot displace in direction D1 or direction D2 with respect thereto. In an exemplary embodiment, and as best shown in FIG. 2E, pin 158 is inserted through nut 154 and rod 152. In an exemplary embodiment, pin 158 is a cotter pin.

To assemble, engaging member 110 is displaced away from plate 90 until the distance between the distal ends of fingers 102 and 116 is greater than the distance between the distal ends of flanges 32 and 34. Clamping assembly 40 is positioned about semi-trailer 20 such that surface 72 of plate 70, for example pad 80, is engaged with side wall 24, and top surface 182 of beam 180 abuts against the bottom surface of beam 30. In this position, fingers 116 and 102 should be arranged above the top surfaces of flanges 34 and 32, respectively. In an exemplary embodiment, finger 102 is engaged with beam 30, namely, the top surface of flange 32. Engaging member 110 is displaced in direction D2 until finger 116 engages the top surface of flange 34. In an exemplary embodiment, engaging member 110 is tightened against beam 30 via tensioning device 150. Clamping assembly 40 is then secured to semi-trailer 20 creating a stable and secure anchor point for a fall restraint system. Line 170 is connected to attachment device 160 and thus secured to semi-trailer 20. The arrangement of clamping device 40, namely, having adjustable sliding engaging member 110, allows it to fit a variety of size and shaped beams and thus universal for use with nearly all trailers.

It will be appreciated that various aspects of the disclosure above and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims.

### REFERENCE NUMERALS

10 Fall restraint assembly

20 Semi-trailer or tractor-trailer

22 Rear

24 Side

26 Top

28 Bottom

30 Beam

32 Flange

34 Flange

36 Front support or landing gear

40 Clamping assembly

50 Arm

52 Plate

54 Slot

56A Groove

56B Groove

58A Plate

58B Plate

60 End

62 End

70 Plate

72 Surface

74 Surface

76 Top

78 Bottom

80 Gripping material or pad

82 Hole

90 Plate

92 Surface

94 Surface

96 Top

98 Bottom

100 Hole

102 Finger

110 Engaging member

112 Top bracket

114 Post

116 Finger

122 Base

124 Through-hole

126 Bottom bracket

128 Post

130 Through-bore

132 Base

134 Through-hole

136 Connector or bolt

138 Connector or nut

150 Tensioning device

152 Rod

154 Connector or nut

156 Knob

158 Pin

160 Attachment device or eyebolt or hook

162 Connector or bolt

164 Connector or nut

170 Line

172 End

174 End

176 Connector

180 Beam

182 Top surface

184 Bottom surface

186 End

188 End

D1 Direction

D2 Direction

D3 Direction

D4 Direction

D5 Direction

D6 Direction

L Line

What is claimed is:

1. A clamping assembly for a fall restraint system, the clamping assembly comprising:
an arm, including:
a first end;
a second end; and
a slot;
a first plate connected to the first end;
an engaging member slidably connected to the arm, the engaging member displaceable in a first direction and a second direction, opposite the first direction;
a second plate connected to the arm and including a first surface and a second surface; and
a tensioning device operatively arranged to displace the engaging member in the second direction.

2. The clamping assembly as recited in claim 1, wherein the second plate is connected to the arm via a beam.

3. The clamping assembly as recited in claim 2, wherein the beam is connected to a top surface of the arm.

4. The clamping assembly as recited in claim 1, wherein the second plate is spaced apart from the arm in a third direction, perpendicular to the first direction and the second direction.

5. The clamping assembly as recited in claim 1, further comprising a coupling device connected to second plate.

6. The clamping assembly as recited in claim 1, wherein the engaging member comprises a top bracket including a first finger.

7. The clamping assembly as recited in claim 6, wherein the top bracket comprises a post and the first finger extends from the post in the second direction.

8. The clamping assembly as recited in claim 6, wherein:
the engaging member further comprises a bottom bracket; and
a connector extends through the bottom bracket, the slot, and the top bracket to slidably connect the engaging member to the arm.

9. The clamping assembly as recited in claim 6, wherein the first plate comprises a second finger extending in the first direction toward the first finger.

10. The clamping assembly as recited in claim 1, wherein the tensioning device comprises a rod connected to the engaging member.

11. The clamping assembly as recited in claim 10, wherein the rod comprises threading and is threadably engaged with the first end.

12. The clamping assembly as recited in claim 10, wherein the rod comprises threading and is threadably engaged with a hole in the first plate.

13. The clamping assembly as recited in claim 1, wherein the first surface comprises a rubber pad.

14. The clamping assembly as recited in claim 1, wherein the coupling device comprises an eyebolt.

15. A fall restraint assembly, comprising:
a clamping assembly, including:
an arm, comprising:
a first end;
a second end; and
a slot;
a first plate connected to the first end;
an engaging member slidably connected to the arm, the engaging member displaceable in a first direction and a second direction, opposite the first direction;
a second plate connected to the arm and including a first surface and a second surface; and
a tensioning device operatively arranged to displace the engaging member in the second direction; and
a line connected to the second plate.

16. The fall restraint assembly as recited in claim 15, wherein:
the clamping assembly further comprises a coupling device connected to the second plate; and
the line is connected to the coupling device.

17. The fall restraint assembly as recited in claim 15, wherein the engaging member comprises a first finger extending in the second direction.

18. The fall restraint assembly as recited in claim 17, wherein the first plate comprises a second finger extending in the first direction.

19. The fall restraint assembly as recited in claim 15, wherein:
the second plate is fixedly secured to the arm via a beam; and
the beam is connected to a top surface of the arm.

20. The fall restraint assembly as recited in claim 15, wherein the first plate is arranged substantially perpendicular to the second plate.
